(19) United States
(12) Patent Application Publication
(10) Pub. No.: US 2004/0098167 A1
(43) Pub. Date: May 20, 2004

(54) Home robot using supercomputer, and home network system having the same

(76) Inventors: Sang-Kug Yi, Yongin-city (KR); Kyong-Joon Chun, Seoul (KR); Jun-Hwa Seo, Suwon-city (KR); Mun-Hyo Jung, Gyeongsangnam-do (KR); Young-Mi Son, Suwon-city (KR)

Correspondence Address: Robert E. Bushnell, Suite 300, 1522 K Street, N.W., Washington, DC, 20005-1202, US

(21) Appl. No.: 10/674,357

(22) Filed: Oct. 1, 2003

(30) Foreign Application Priority Data
Nov. 18, 2002 (KR) 71671/2002

(51) Int. Cl. G06F 19/00

(52) U.S. Cl. 700/245

(57) ABSTRACT

A home robot controlled by a remote supercomputer. When a user gives a voice command to the home robot, the home robot A/D converts the voice command and transmits the converted command to the supercomputer through a home gateway and a communication network. A control unit in the supercomputer interprets the voice command. Service modules produce appropriate response commands based on the interpreted voice command. The response commands are transmitted to the home robot over a communication network A control unit in the home robot receives the response commands, and upon analysis thereof, controls one or more actions of the home robot by generating one or more of a digital voice signal, motion control signal and an image signal. The digital voice signal is converted to an analog signal for reproduction through a speaker. A driving unit moves body components of the home robot in response to one or more of the motion control signals from the control unit. A display unit displays an image in response to the image signal.

### CLAIM OF PRIORITY

This application claims priority to an application entitled “HOME ROBOT USING COMPUTER, AND HOME NETWORK SYSTEM HAVING THE SAME”, filed in the Korean Intellectual Property Office on Nov. 18, 2002 and assigned Serial No. 2002-71671.

### BACKGROUND OF THE INVENTION

1. Field of the Invention

The present invention relates to a home robot using a supercomputer and a home network system having the same, and more particularly to, a home robot using a supercomputer and a home network system having the same which can minimize processing operations of the robot, perform the other processing operations in the supercomputer through a network, and enable the robot to perform a command of a user by using the processing results.

2. Description of the Related Art

A robot is a machine designed to execute one or more tasks repeatedly, with speed and precision. There are as many different types of robots as there are tasks for them to perform.

A robot can be controlled by a human operator, sometimes from a great distance. But most robots are controlled by computer, and fall into either of two categories: autonomous robots and insect robots. An autonomous robot acts as a stand-alone system, complete with its own computer. Insect robots work in fleets ranging in number from a few to thousands, with all fleet members under the supervision of a single controller. The term insect arises from the similarity of the system to a colony of insects, where the individuals are simple but the fleet as a whole can be sophisticated.

Robots are sometimes grouped according to the time frame in which they were first widely used. First-generation robots date from the 1970s and consist of stationary, nonprogrammable, electromechanical devices without sensors. Second-generation robots were developed in the 1980s and can contain sensors and programmable controllers. Third-generation robots were developed between approximately 1990 and the present. These machines can be stationary or mobile, autonomous or insect type, with sophisticated programming, speech recognition and/or synthesis, and other advanced features. Fourth-generation robots are in the research-and-development phase, and include features such as artificial intelligence, self-replication, self assembly, and nanoscale size (physical dimensions on the order of nanometers, or units of 10⁻⁹ meter).

A cobot or “collaborative robot” is a robot designed to assist human beings as a guide or assistor in a specific task. A regular robot is designed to be programmed to work more or less autonomously. In one approach to cobot design, the cobot allows a human to perform certain operations successfully if they fit within the scope of the task and to steer the human on a correct path when the human begins to stray from or exceed the scope of the task.

Some advanced robots are called androids because of their superficial resemblance to human beings. Androids are mobile, usually moving around on wheels or a track drive (robots legs are unstable and difficult to engineer). The android is not necessarily the end point of robot evolution. Some of the most esoteric and powerful robots do not look or behave anything like humans. The ultimate in robotic intelligence and sophistication might take on forms yet to be imagined.

A robot which incorporates a body, two arms, two legs, several sensors, an audio system, a light assembly, and a video device is the subject of U.S. Pat. No. 6,507,773 to Andrew J. Parker et al. and entitled “Multi-functional Robot with Remote and Video System.” Sensors located throughout the body of the robot combined with an edge detection sensor allows the robot to interact with objects in the room, and prevents the robot from traveling off an edge or bumping into obstacles. An audio system allows the robot to detect and transmit sounds. A video device allows a user to remotely view the area in front of the robot. Additionally, the robot may operate in a plurality of modes which allow the robot to operate autonomously. The robot may operate autonomously in an automatic mode, a security mode, a greet mode, and a monitor mode. Further, the robot can be manipulated using a remote control.

U.S. Pat. No. 6,560,511 to Naohiro Yokoo, et al. and entitled “Electronic Pet System, Network System, Robot, and Storage Medium” discusses connection of a robot to the Internet via modems or by Bluetooth modules, which are radio means. In such a case, the robot and a virtual electronic pet device or a personal computer have Bluetooth modules, respectively, as radio transmission/reception sections. Accordingly, the modems or Bluetooth modules are connected to the Internet (e.g., public telephone network) and data transmission/reception is carried out with the Bluetooth module in the robot and the Bluetooth module of the virtual electronic pet device or personal computer. In this case, the Bluetooth is a radio interface using ISM (industrial Scientific Medical) band of 2.4 GHz which does not require permission as the carrier frequency.

U.S. Pat. No. 6,577,924 to Tomoaki Kasuga, et al. entitled “Robot Managing System, Robot Managing Method, and Information Managing Device” discusses connection of a robot to the Internet via a server and personal computer. The personal computer has both a function to send information on a robot to a telecommunication line and a function to receive answer information sent from a server to the robot user via the telecommunication line, and the server generates answer information on the basis of robot-related information sent from the personal computer via the telecommunication line and reference information previously stored in an information storage device and corresponding to the robot-related information and sends the answer information to the personal computer via the telecommunication line. The answer information is a diagnostic report on the robot.

U.S. Pat. No. 6,584,376 to Robert Van Kommer entitled “Mobile Robot and Method for Controlling a Mobile Robot” describes a mobile robot including an autonomous displacement device, a microphone, a loudspeaker, a mobile telephone module, and a voice analysis module able to interpret voice commands through the mobile telephone module to control the displacements of the mobile robot.

FIG. 1 is a structure view illustrating a personal robot disclosed in Korean Laid-Open Patent 200-016048 by Jin Yeong Jung et al., published 5 Mar. 2001, and entitled “Multipurpose Home Personal Robot” relating to a multi-function home personal robot in which the function of the robot is incorporated into a remote computer.

As illustrated in FIG. 1, a home personal robot 200 processes an image sensed by an image sensor 201 in an image processing unit 207, processes voice sensed by a voice sensor 202 in a voice processing unit 208, and remotely transmits them through a wireless communication module 212. The home personal robot 200 includes a speaker 203 for reproducing voice, a display unit 204 for reproducing the image, a motion processing unit 210 for processing motions, a motor array 206 and an obstacle detecting module 205. In addition, the home personal robot 200 includes a main control unit 209 for controlling each module and a storage unit 211 for storing data.

The home personal robot 200 performs commands of the user, sensing data and other robot operations in the main control unit 209 and auxiliary processors of each module, namely the image processing unit 207, the motion processing unit 210 and the voice processing unit 208. On the other hand, a communication function is used to input/output the commands of the user or remotely upgrade a software required for the robot.

The robot described above is designed to process low level processing operations as well as high level processing operations in its microprocessors (main processor and auxiliary processors).

Accordingly, the robot requires a plurality of processors, which increases a unit cost. The robot also rapidly consumes battery power due to its increased weight. Because an operation speed of the robot is dependent upon performance of the processor of the main control unit 209, the robot cannot smoothly perform a high level processing command requiring large capacity calculations.

### SUMMARY OF THE INVENTION

It is, therefore, an object of the present invention to provide a home robot using a supercomputer and a home network system having the same which can minimize a processing load and a unit cost of the robot.

To achieve the above object, there is provided a system for controlling a home robot, including: a remote supercomputer responsive to a user's command for controlling said home robot, said user and said home robot being in a premises different from a location of said supercomputer; a home gateway for providing a path of communication between said home robot and said supercomputer via a network external to said premises; and said home robot being controlled to perform only in response to command result signals generated by said supercomputer, said command result signals being generated in response to said user's command.

According to another aspect of the invention, A system for controlling a home robot, the system including the home robot, a home gateway and a supercomputer for controlling said home robot, said supercomputer including: a home gateway interface unit for receiving user's commands via said home gateway and over a communication network; a control unit for extracting and interpreting one or more commands of the user and a status signal of the home robot from the user's commands received by the home gateway interface unit, said control unit generating a command response signal in response to each interpreted command and a status response signal in response to the status signal; a service module unit responsive to each said command response signal for generating corresponding command result signals and responsive to said status response signal for generating corresponding status result signals, said command result signals and status result signals being transmitted to said home robot via said control unit and said home gateway interface unit over said network; and a robot information managing unit for managing a general history of the home robot such as registration information, operation information, accident information and residential position for operations of the control unit.

According to another aspect of the invention, a method for operating a home robot using a supercomputer includes: receiving a voice command of a user at the home robot, digitally converting the voice command, and transmitting the converted command to the supercomputer through a home gateway; interpreting the voice command transmitted from the home robot through the home gateway at the supercomputer, generating a voice signal in response to the voice command, and transmitting the voice signal to the home robot through the home gateway; and reproducing the voice signal transmitted from the supercomputer through the home gateway at the home robot as audio voice through a speaker.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a related prior art multi-function home personal robot;

FIG. 2 is a block diagram illustrating a home network in accordance with a preferred embodiment of the present invention;

FIG. 3 is a block diagram illustrating a supercomputer of FIG. 2; and

FIG. 4 is a block diagram illustrating a home robot of FIG. 2.

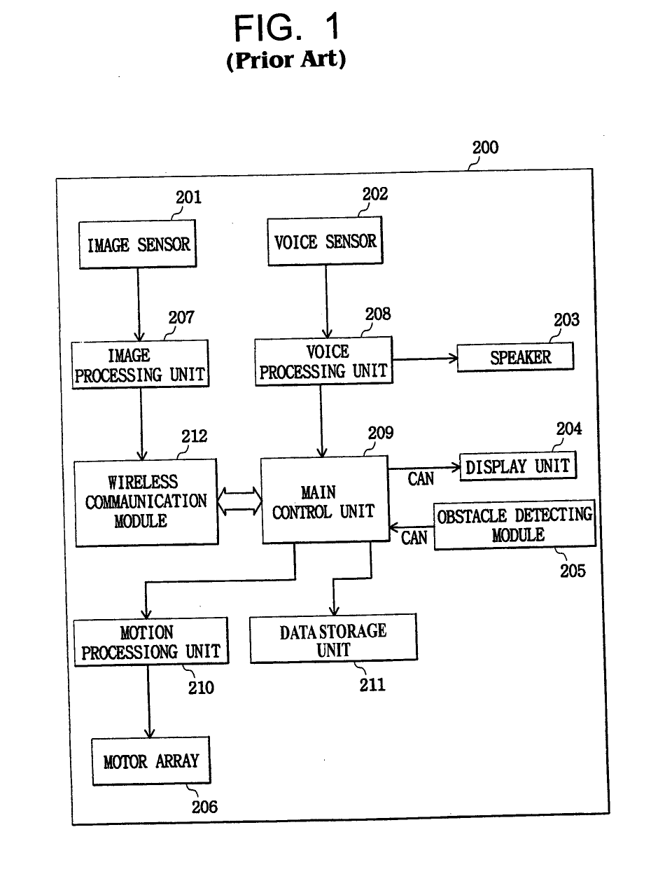

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are provided to assist in a comprehensive understanding of the invention. However, the present invention can be carried out without those defined matters. Also, well-known functions or constructions are not described in detail since they would obscure the invention in unnecessary detail.

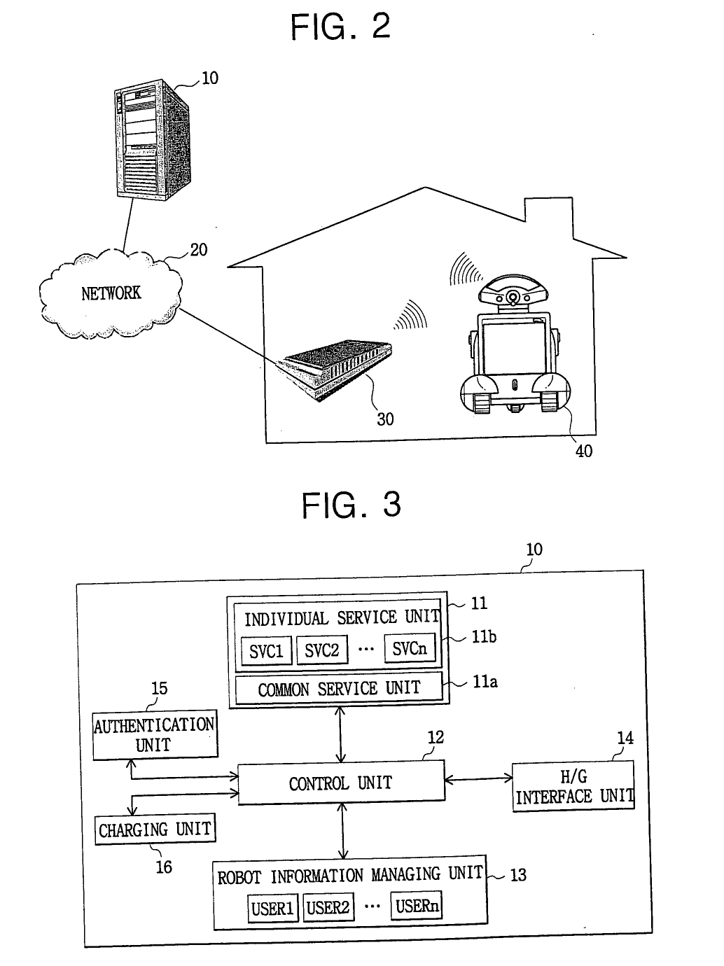

FIG. 2 is a block diagram illustrating a network in accordance with the preferred embodiment of the present invention. The network includes a supercomputer 10, a physical network 20, a home gateway 30 and a home robot 40.

In general, a network is a series of points or nodes interconnected by communication paths. Networks can interconnect with other networks and contain subnetworks. The most common topology or general configurations of networks include the bus, star, and token ring topologies. Networks can also be characterized in terms of spatial distance as local area networks (LAN), metropolitan area networks (MAN), and wide area networks (WAN). A given network can also be characterized by the type of data transmission technology in use on it (for example, a TCP/IP or Systems Network Architecture network); by whether it carries voice, data, or both kinds of signals; by who can use the network (public or private); by the usual nature of its connections (dial-up or switched, dedicated or nonswitched, or virtual connections); and by the types of physical links (for example, optical fiber, coaxial cable, and Unshielded Twisted Pair). Large telephone networks and networks using their infrastructure (such as the Internet) have sharing and exchange arrangements with other companies so that larger networks are created. A gateway is a network point that acts as an entrance to another network. On the Internet, a node or stopping point can be either a gateway node or a host (end-point) node. Both the computers of Internet users and the computers that serve pages to users are host nodes. The computers that control traffic within your company's network or at your local Internet service provider (ISP) are gateway nodes. In the network for an enterprise, a computer server acting as a gateway node is often also acting as a proxy server and a firewall server. On the Internet, a node or stopping point can be either a gateway node or a host (end-point) node. Both the computers of Internet users and the computers that serve pages to users are host nodes. The computers that control traffic within a company's network or at a local Internet service provider (ISP) are gateway nodes. A gateway is often associated with both a router, which knows where to direct a given packet of data that arrives at the gateway, and a switch, which furnishes the actual path in and out of the gateway for a given packet. A supercomputer is a computer that performs at or near the currently highest operational rate for computers.

According to the present invention, supercomputer 10 receives a wireless signal from home robot 40 through home gateway 30. When receiving the wireless signal from home robot 40 through home gateway 30, supercomputer 10 extracts and interprets a command of a user and a status signal of home robot 40 from the wireless signal, and performs operations for the command of the user and operations for controlling driving of the robot. In addition, supercomputer 10 generates a voice response signal or image response signal which will be reproduced by home robot 40, and a driving control signal of home robot 40 for controlling the driving of home robot 40 according to the operation results, and transmits the signals to home robot 40 through home gateway 30.

In order for home robot 40 to initially start operating in response to commands from supercomputer 10, a process for registering information pertaining to home robot 40 in a database of supercomputer 10 is performed. Here, the registration process is performed once, and is necessary for communication between supercomputer 10 and home robot 40. It is similar to a process for registering an intrinsic ID of a cellular phone in a mobile communication provider when the cellular phone is first used.

When the user gives a voice command to the home robot 40 after the registration, the home robot 40 digitally converts the voice command, and transmits corresponding command data to supercomputer 10 through home gateway 30. No other process is performed in the home robot 40 in response to the user's voice. The method for giving the command to home robot 40 is not restricted to voice picked up by a microphone, but may also use a touch screen or a wireless keyboard (remote control). However, the present invention supposes the simplest structure of the home robot 40, and thus explanations of the other known types are omitted.

For further understanding of the invention described below, a wireless LAN (WLAN) is one in which a user can connect to a local area network (LAN) through a wireless (radio) connection. A standard, IEEE 802.11, specifies the technologies for wireless LANs. The IEEE standard includes an encryption method, the Wired Equivalent Privacy algorithm, which may or may not be used in the present invention.

When receiving the WLAN command data from home robot 40, home gateway 30 converts the WLAN command data into data suitable for an external network (e.g., Internet) 20 which the home gateway 30 accesses, adds an ID of the home robot 40 to the data and transmits it to supercomputer 10. In this case, home gateway 30 constantly accesses home robot 40.

The supercomputer 10 confirms the home gateway 30 location and the ID of the home robot 40, and then performs a requested command. Therefore, if the robot is lost or stolen, no security problems are generated. That is, in order for supercomputer 10 to control home robot 40, home robot 40 must be at the same location as home gateway 30 and the ID of home robot 40 must be stored in home gateway 30.

The supercomputer 10 quickly analyzes the command data using an internal voice recognizing module, obtains a voice command result and operates a corresponding service module. A service request command may request a common service or an individual service.

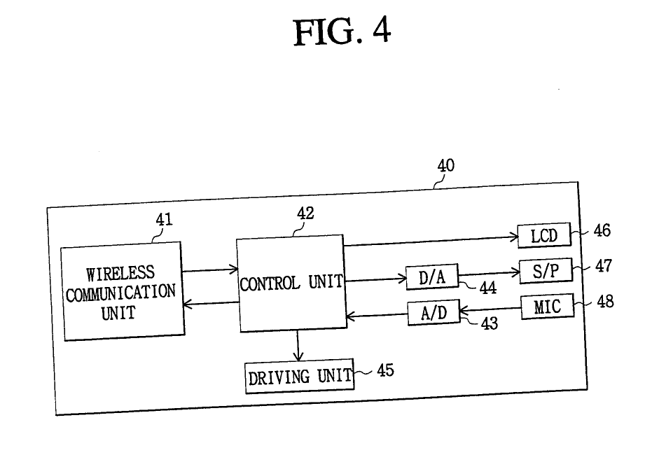

The home robot 40 can be composed of basic modules such as a CPU, a microphone, an LCD, a speaker and a network module. That is, the home robot 40 does not have to include sub-processors by functions and modules like a general robot. It is thus possible to reduce a unit cost and battery consumption by forming the home robot 40 with a minimum number of basic modules. The home robot 40 will be further discussed in connection with FIG. 4.

FIG. 3 is a detailed block diagram illustrating the supercomputer 10 in accordance with the preferred embodiment of the present invention. A method for constituting service modules which will now be explained is just one example, and thus service modules for providing various services can be added or modified.

Referring to FIG. 3, supercomputer 10 includes a service module 11, a control unit 12, a robot information managing unit 13, a home gateway (H/G) interface unit 14, an authentication unit 15 and a charging unit 16.

The service module 11 enables the supercomputer 10 to control the home robot 40. The service module 11 includes a common service module (Common SVC) 11a and individual service modules (SVC1, SVC2, . . . SVCn) 11b. If necessary, service modules can be added or deleted.

The common service module 11a implies a common service provided to all users, and the individual service modules 11b imply services individually provided to each user. A service policy can be made to charge a fee for the individual services/users.

For example, exemplary service modules include a voice recognition module for recognizing a voice command of the user, and a voice synthesizing module for synthesizing and reproducing voice.

In addition, a home robot driving managing module for driving the home robot 40, an electric home appliance control module or an Internet information search module can be embodied. The electric home appliance control module controls electric home appliances, and the Internet information search module searches and provides Internet information to the user.

Also, the supercomputer 10 can include modules for building a map and controlling a path of the robot. The map building function enables the home robot 40 to obtain image information and create a map in a new environment. A lot of related prior patents have been secured for registration, and thus it can be easily embodied by those skilled in the art.

The path control function forms an optimal robot path from one point to another by using information from a distance discriminating sensor. A lot of related prior patents have been secured for registration, and thus it can be easily embodied by those skilled in the art.

The control unit 12 extracts and interprets the command of the user and the status signal of the robot from the wireless signal generated by the home robot 40 and converted by home gateway 30 and home gateway interface unit 14, performs operations according to the command of the user and operations for controlling driving of the home robot 40, generates a voice response signal or image response signal, which will be reproduced by the home robot 40, and the driving control signal for controlling driving of the home robot 40 according to the operation results, and outputs the signals to the home gateway 30 via home gateway interface unit 14. The operation status of the home robot 40 will be displayed on the LCD 46.

The robot information managing unit 13 manages information of each home robot 40 for operations of the control unit 12. As shown in FIG. 3, there may be more than one user and each user may have a different home robot and corresponding information. Accordingly, the supercomputer 10 may be connected via one or more networks to one or more home gateways and corresponding home robots, at one or more locations.

The information of the home robot 40 managed by the robot information managing unit 13 is a general history of the home robot 40 such as registration information, operation information, accident information and residential position. The registration information has an ID of the home robot 40, a product number and product specifications of the home robot 40, and personal information of an owner (name, address, phone number and resident registration number). The personal information is not essential but efficient to manage the home robot 40.

The home gateway interface unit 14 receives a signal from the home robot 40 through the home gateway 30, or transmits a response signal or performance control signal to the home robot 40 through the home gateway 30.

When the home robot 40 transmits information through the home gateway 30 or requests a service, the authentication unit 15 in supercomputer 10 authenticates the home robot 40. Authentication modules are known (e.g. cell phone authentication),and thus a detailed explanation thereof is omitted.

The charging unit 16 is a functional module for charging fees (expenses) when the home robot 40 uses the supercomputer 10. Modules for charging fees are has also known, and thus a detailed explanation thereof is omitted.

FIG. 4 is a block diagram illustrating the home robot in accordance with the preferred embodiment of the present invention.

As depicted in FIG. 4, the home robot includes a wireless communication unit 41, a control unit 42, an A/D (analog-to-digital) converter 43, a D/A (digital-to-analog) converter 44, a driving unit 45, an LCD (liquid crystal display) 46, a speaker 47 and a microphone 48.

The wireless communication unit 41 converts the digital signal generated A/D converter 43 and control unit 41 into a wireless (WLAN) signal, and transmits the wireless signal to the home gateway 30. In addition, the wireless communication unit 41 receives a wireless signal from the home gateway 30, converts it to a digital signal and transmits the digital signal to the control unit 42.

When receiving a voice command from the user via the microphone 48, the A/D converter 43 digitally converts the voice signal to transmit it to the control unit 42 which in turn transmits the voice command to the supercomputer 10 by way of the wireless communication unit 41 and the home gateway 30.

When the supercomputer 10 interprets the command and makes a response to the command, the control unit 42 receives a response result through the home gateway 30 and the wireless communication unit 41. The control unit 42 then transmits the response result to either the D/A converter 44 for conversion to an analog voice signal for audio output by speaker 47, or generates a motion control signal for moving one or more components of the home robot 40 and transmits the motion control signal to driving unit 45, or converts it to an image signal for display by LCD 46.

A memory of the control unit 42 requires minimum memory specifications to serve as a kind of cache. Therefore, a large capacity memory for processing a lot of signals is not necessary.

The A/D converter 43 and the D/A converter 44 are distinguished from the related arts in that they perform minimum functions for digital communication.

The microphone 48 receives the voice signal from the user, converts it into an electric signal, and transmits the electric signal to the A/D converter 43.

As described above, the home robot 40 of the invention is composed of a minimum number of modules.

The home robot 40 can be easily constituted by those skilled in the art which the present invention pertains to. If necessary, it can further include an image sensor such as a sensor camera or other sensors, such as sonic sensors, infrared sensors, etc.

The home robot 40 of the invention serves as a mobile interface device or a remote controller.

The supercomputer 10 and the home robot 40 communicate with each other through the home gateway 30. For this, the home robot 40 includes the wireless communication unit 41 which is a network module. Preferably, a digital wireless communication module is used as the network module. Various types of network modules can be used, but a high data rate network module is preferably used. For example, in the case of IEEE 802.11b WLAN, a data rate of 10 Mbps is obtained, and in the case of IEEE 802.11 WLAN, a data rate of 50 Mbps is obtained. In the preferred embodiment of the present invention, the communication module having a data rate of at least 10 Mbps is recommended.

The uses of the home robot 40 are generally restricted to within a user's premises. Therefore, a data rate is rarely restricted by a communication distance between the home gateway 30 and the home robot 40.

When the supercomputer 10 receives a voice command from the home robot 40 through the home gateway 30, the supercomputer 10 analyzes the command through a voice recognition module of service module 11, and transmits the analysis, or command result, of the command to the control unit 12. The control unit 12 performs corresponding operations, obtains a voice command result, and operates one or more of the service modules of the service module 11 corresponding to the command result.

For example, in order to move the home robot 40, control unit 12 provides the command result to service module 12 and a corresponding motion control module generates a motion control signal that is returned to the control unit 12 for transmission via home gateway interface unit 14 to home robot 40 via home gateway 30. Thus, supercomputer 10 transmits the motion control signal for moving the home robot 40 to the home robot 40.

Various individual service modules 11b can be added to the supercomputer 10, and thus individual users can use services provided by the supercomputer 10 through the home robot 40.

For example, an electric home appliance control module or an Internet information search module can be added to the service module 11 of the supercomputer 10 to control the user's electric home appliances, or search and provide Internet information to the user.

Accordingly, when a user desires for the home robot to turn the television on, by voice command or remote control command, the electric home appliance control module of the service module 11 is operated to generate a TV ON command, which is then transmitted to the home robot 40.

In addition, in the case of an Internet information search function, when the command is a next day weather forecasting command, the Internet information search module is operated to obtain a result. The result can be sent as an image signal or into voice signal. When transmitting the result as a voice signal, a voice synthesizing module of the service module 11 is utilized to convert the result to digital voice information for transmission to the home robot 40 through the home gateway 30. The home robot 40 digital-to-analog converts the voice information in the D/A converter 44, and notifies the user through the speaker 47.

On the other hand, if the result is to be sent as an image signal, the supercomputer 10 can directly transmit the Internet search information to the home robot 40 through the home gateway 30, and the home robot 40 can notify it to the user through the screen of the LCD 46.

In accordance with another aspect of the invention, a messenger function can be performed. That is, the user gives a command for transmitting a message to another person to the home robot 40. In this case, the home robot 40 may require a camera and a distance discriminating sensor.

In addition, as mentioned earlier, the supercomputer 10 can include modules for building a map and controlling a path of the robot. The map building function enables the home robot 40 to obtain image information and create a map in a new environment. The path control function forms an optimal robot path from one point to another by using information from the distance discriminating sensor.

When a user in one room gives a command to the home robot 40 for transmitting a message to a user in another room, the home robot 40 appears to understand and perform the command of the user. Here, the supercomputer 10 actually interprets the command of the user, but due to the speed of the supercomputer 10, the home robot 40 performs as if it understood the command.

Since the home robot 40 needs to move from one location to another, the current position of the home robot 40 is continuously transmitted to the supercomputer 10 through the home gateway 30, and the supercomputer 10 builds the optimal path to control the home robot 40 to move to the room in which the user receiving the message is in according to the current position information of the home robot 40, the map building function and the path control function.

The home robot 40 moves, according to the command of the supercomputer 10, without making any decision. When the home robot 40 reaches the desired location, the supercomputer 10 transmits the message, which it has received from the home robot 40 through the home gateway 30 and stored in its memory, to the home robot 40, and the home robot 40 provides the message to the designated user via speaker 47.

A face recognizing module can be used to confirm whether the designated user is absent. If the home robot 40 meets the designated user, the supercomputer 10 transmits the message to the home robot 40 to reproduce it through speaker 47.

The possible problem of the operation is whether to perform the operation in a real time. However, a motion speed of the home robot 40 is not high, maximally 50 cm/sec, the supercomputer 10 and the home gateway 30 currently communicate at a few tens Mbps and are expected to communicate at giga-level bps, and the home gateway 30 and the home robot 40 are expected to communicate at minimally a few tens Mbps. It is thus easy to obtain the real time property.

Furthermore, the home robot 40 can be used for a home monitoring service. That is, a database is built in the supercomputer 10 by transmitting information on humans, electric home appliances and crime prevention to the supercomputer 10 through the home gateway 30 in order to analyze and handle specific cases. Here, the database built in the supercomputer 10 has been publicly known and used in various fields, and thus detailed explanations thereof are omitted.

Moreover, the home robot 40 can be employed in an education field. That is, when receiving a voice question from the user, the home robot 40 digitally converts the voice question in the A/D converter 43, and transmits it to the supercomputer 10 through the wireless communication unit 41 and the home gateway 30. The supercomputer 10 searches for an answer to the voice question, and transmits it as a voice signal to the home robot 40. The home robot 40 receives the voice signal through the wireless communication unit 41, converts the voice signal in the D/A converter 44, and reproduces the converted signal through the speaker 47, thereby performing an explanation and answer function to the voice question.

If the user intends to use the home robot 40 in other places, the home robot 40 must include a wireless telephone modem. For example, it can use CDMA 2000x EV-DO modem. In addition, if the home robot 40 has a telephone number like a cellular phone, it can communicate with the supercomputer 10 through a wireless public switched network in other places. However, the authentication procedure must be performed by using the ID of the home robot 40.

In accordance with the present invention, large capacity processing operations which have not been successfully performed by a high-priced robot can be successfully performed by a low-priced robot. The user can be continuously provided with high-quality services because the hardware of the robot needs not be replaced during the service upgrading.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for controlling a home robot, comprising:
a remote supercomputer responsive to a user's command for controlling said home robot, said user and said home robot being in a premises different from a location of said supercomputer;
a home gateway for providing a path of communication between said home robot and said supercomputer via a network external to said premises; and
said home robot being controlled to perform only in response to command result signals generated by said supercomputer, said command result signals being generated in response to said user's command.

2. The system as set forth in claim 1, said home robot comprising:
a microphone for receiving an external voice command signal from the user and converting the voice command signal into an electric command signal;
an analog-to-digital converter for converting the electric command signal to a digital command signal;
a wireless communication unit for converting the digital command signal into a wireless command signal and transmitting the wireless command signal to the supercomputer through said home gateway and said network, and for receiving a wireless command result signal from the supercomputer through the network and the home gateway, said wireless communication unit converting the wireless command result signal into a digital command result signal;
a digital-to-analog converter for converting a digital voice signal to an analog voice signal when said digital voice signal is included with said digital command result signal;
a speaker for producing an audio voice signal in response to the analog voice signal from said digital-to-analog converter;
a control unit receiving said digital command result signal from the wireless command unit and analyzing said digital command result signal to control one or more actions of said home robot, and based on said analysis, said control unit outputting one or more of said digital voice signal, motion control signals and an image signal;
a driving unit for moving body components of said home robot in response to one or more of said motion control signals from the control unit, each motion control signal being determined by the analysis performed by said control unit on said digital command result signal; and
a display unit for displaying an image in response to said image signal.

3. The system as set forth in claim 2, said control unit transmitting the digital command signal to said wireless communication unit.

4. The system as set forth in claim 2, said wireless communication unit generating and receiving wireless local area network (WLAN) signals.

5. The system as set forth in claim 2, said home gateway converting said wireless command signal to a form appropriate to said network for communication over said network as a transmitted command signal.

6. The system as set forth in claim 1, the path of communication between said home robot and said home gateway being a wireless local area network (WLAN).

7. The system as set forth in claim 1, said supercomputer comprising:
a home gateway interface unit for receiving said user's command via said home gateway and said network;
a control unit for extracting and interpreting one or more commands of the user and a status signal of the home robot from the user's commands received by the home gateway interface unit, said control unit generating a command response signal in response to each interpreted command and a status response signal in response to the status signal; and
a service module unit responsive to each said command response signal for generating corresponding command result signals and responsive to said status response signal for generating corresponding status result signals, said command result signals and status result signals being transmitted to said home robot via said control unit and said home gateway interface unit over said network.

8. The system as set forth in claim 7, said supercomputer further comprising:
an authentication unit for authenticating the home robot, when the home robot transmits information through the home gateway or requests a service;
a charging unit for charging a fee when the home robot uses the supercomputer; and
a robot information managing unit for managing a general history of the home robot, the general history comprising one or more of registration information, operation information, accident information and residential position.

9. The system as set forth in claim 1, said supercomputer comprising an authentication unit for authenticating the home robot, when the home robot transmits information through the home gateway or requests a service to enable said supercomputer and said home robot to communicate with each other.

10. A system for controlling a home robot, the system comprising the home robot, a home gateway and a supercomputer for controlling said home robot, said supercomputer comprising:
a home gateway interface unit for receiving user's commands via said home gateway and over a communication network;
a control unit for extracting and interpreting one or more commands of the user and a status signal of the home robot from the user's commands received by the home gateway interface unit, said control unit generating a command response signal in response to each interpreted command and a status response signal in response to the status signal;
a service module unit responsive to each said command response signal for generating corresponding command result signals and responsive to said status response signal for generating corresponding status result signals, said command result signals and status result signals being transmitted to said home robot via said control unit and said home gateway interface unit over said network; and
a robot information managing unit for managing a general history of the home robot such as registration information, operation information, accident information and residential position for operations of the control unit.

11. The system as set forth in claim 10, said supercomputer further comprising:
an authentication unit for authenticating the home robot, when the home robot transmits information through the home gateway or requests a service, communication between the home robot and the supercomputer being enabled upon authentication of the home robot; and
a charging unit for charging a fee when the home robot uses the supercomputer.

12. The system as set forth in claim 10, said service module comprising:
a common service module unit for providing a common service to all users; and
an individual service module unit for providing individual services to each user.

13. The system as set forth in claim 10, said service module comprising:
a voice recognizing module for recognizing a voice command;
a voice synthesizing module for synthesizing and reproducing voice; and
a home robot driving managing module for generating the motion control signals for driving the home robot.

14. The system as set forth in claim 10, wherein the registration information comprises at least one of an ID (identification) of the home robot, a product number and product specifications of the home robot and personal information of an owner of the home robot.

15. The system as set forth in claim 10, the communication network being a wireless local area network (WLAN).

16. A method for operating a home robot using a supercomputer, the method comprising steps of:
receiving a voice command of a user at the home robot;
converting the voice command into a digital voice command;
transmitting the digital voice command to the supercomputer through a home gateway;
interpreting the digital voice command transmitted from the home robot through the home gateway at the supercomputer by voice recognition;
generating a response message to the voice command;
synthesizing the response message into a synthesized voice message
transmitting the synthesized voice message to the home robot through the home gateway; and
converting the synthesized voice message to produce an analog voice signal to generate an audible voice through a speaker.

17. The method as set forth in claim 16, said step of transmitting the digital voice command to the supercomputer through a home gateway comprising steps of:
converting the digital voice command to a wireless local area network (WLAN) signal;
transmitting the wireless local area network (WLAN) signal to said home gateway from said home robot; and
converting the wireless local area network (WLAN) signal to a form suitable for transmission over a communication network connected between said supercomputer and said home gateway.
